(19) United States
(12) Patent Application Publication
(10) Pub. No.: US 2026/0349323 A1
(43) Pub. Date: Nov. 5, 2026

(54) PROJECTOR, CONTROL DEVICE, AND NON-TRANSITORY COMPUTER-READABLE STORAGE MEDIUM STORING PROGRAM

(71) Applicant: SEIKO EPSON CORPORATION, Tokyo (JP)

(72) Inventors: Keita TSUKIOKA, Matsumoto-shi (JP); Kazunori MAETA, Matsumoto-shi (JP); Kodai FURUKAWA, Matsumoto-shi (JP); Hitoshi HIRANO, Suwa-shi (JP); Takanori FUKUYAMA, Matsumoto-shi (JP)

(21) Appl. No.: 19/660,738

(22) Filed: Apr. 28, 2026

(30) Foreign Application Priority Data
Apr. 30, 2025 (JP) 2025-075463

(51) Int. Cl. G03B 21/20; G02B 7/02; G02B 27/00; G03B 21/16

(52) U.S. Cl. CPC G03B 21/208; G02B 7/028; G02B 27/0068; G03B 21/16

(57) ABSTRACT

A projector includes a projection lens and a control device that controls focus of the projection lens, and the control device performs drift cancellation shift of linearly changing the focus position based on a focus change rate from a focus starting point until a quasi-steady state is reached.

The present application is based on, and claims priority from JP Application Serial Number 2025-075463, filed Apr. 30, 2025, the disclosure of which is hereby incorporated by reference herein in its entirety.

### BACKGROUND

### 1. Technical Field

The present disclosure relates to a projector, a control device, and a non-transitory computer-readable storage medium storing a program.

### 2. Related Art

A projector that controls a projection optical device so as to be able to clearly display a projection image both at a low temperature and at a high temperature in accordance with a measured operation time is known to the public (JP-A-2012-042780).

JP-A-2012-042780 is an example of the related art.

In the technique disclosed in JP-A-2012-042780, a specific control method of how to clearly display the projection image is unclear.

### SUMMARY

A projector according to an aspect of the present disclosure includes: a projection lens; and a control device configured to control focus of the projection lens, wherein the control device performs drift cancellation shift for linearly changing a focus position based on a focus change rate from a focus starting point until a quasi-steady state is reached.

A control device according to an aspect of the present disclosure is a control device configured to control focus of a projection lens of a projector, wherein drift cancellation shift that linearly changes a focus position based on a focus change rate from a focus starting point until a quasi-steady state is reached is performed.

A non-transitory computer-readable storage medium storing a program according to an aspect of the present disclosure is a non-transitory computer-readable storage medium storing a program configured to control focus of a projection lens of a projector, including causing an arithmetic device to execute drift cancellation shift that linearly changes a focus position based on a focus change rate from a focus starting point until a quasi-steady state is reached.

### BRIEF DESCRIPTION OF THE DRAWINGS

FIG. 1 is a plan view illustrating a structure of a projector of an embodiment.

FIG. 2 is a side view illustrating an example of a use state of the projector.

FIG. 3 is a block diagram illustrating a control device of the projector.

FIG. 4 is a functional block diagram of the control device.

FIG. 5 is a diagram illustrating a change over time in a focus position of the projector.

FIG. 6 is a diagram illustrating a focus correction in an AF mode.

FIG. 7 is a diagram illustrating another focus correction in the AF mode.

FIG. 8 is a diagram illustrating a focus correction in an MF mode.

FIG. 9 is a diagram illustrating another focus correction in the MF mode.

FIG. 10 is a diagram illustrating an example of a focus adjustment operation of the projector.

FIG. 11 is a diagram illustrating an AF adjustment operation.

FIG. 12 is a diagram illustrating an MF adjustment operation.

FIG. 13 is a diagram illustrating a modified example of the focus correction.

### DESCRIPTION OF EMBODIMENTS

### Embodiment

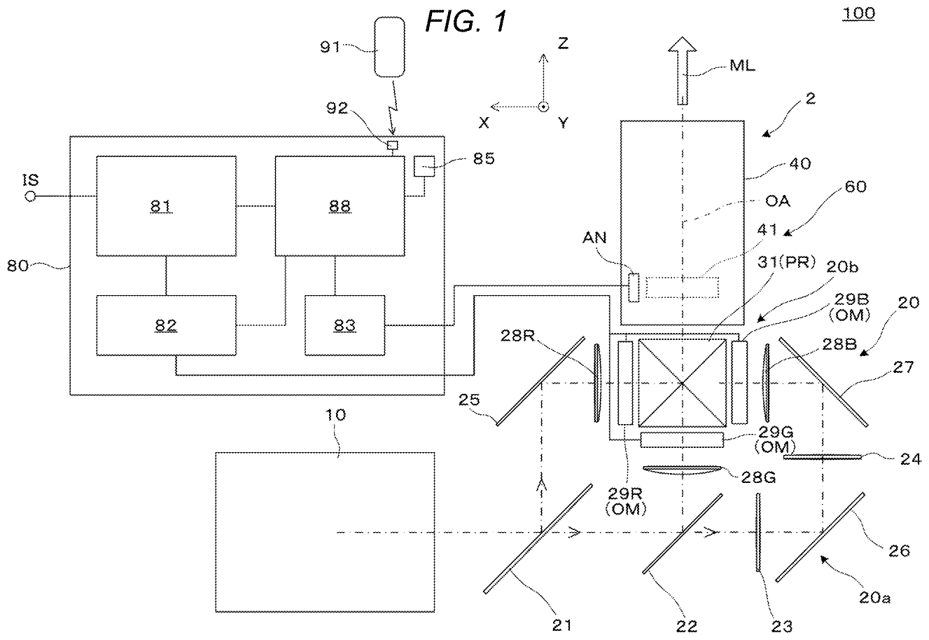

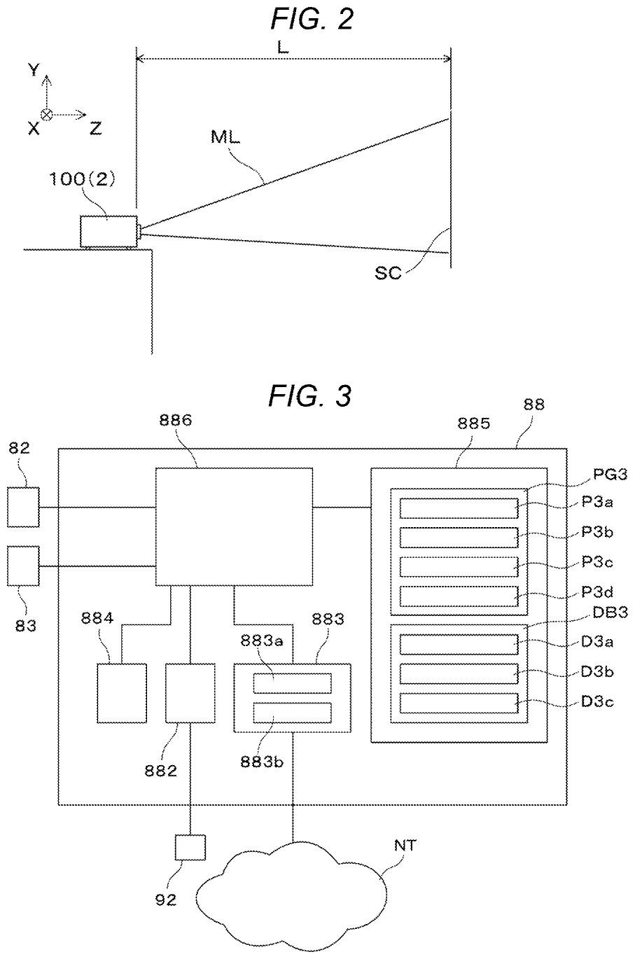

A projector according to an embodiment of the present disclosure will be described below with reference to the drawings. FIG. 1 is a plan view illustrating a structure of a projector 100 according to the embodiment. FIG. 2 is a side view illustrating an example of a use state of the projector 100. Hereinafter, in some cases, a blue color may be referred to as a “B color”, a blue light may be referred to as a “B light”, a green color may be referred to as a “G color”, green light may be referred to as “G light”, a red color may be referred to as an “R color”, and red light may be referred to as “R light”.

As shown in FIG. 1, the projector 100 includes, in a main body 2, an optical system portion 60 that projects image light ML or video light and a circuit device 80 that controls an operation of the optical system portion 60. Although details will be described later, the projector 100 according to the present embodiment controls a focus position so as to follow a temporal change in the focus state caused by a temperature drift. The temperature drift is an error or fluctuation occurring in the device due to a temperature change.

The optical system portion 60 includes an image display device 20 that displays the image light ML, and a projection optical system 40 that projects the image light ML onto a screen SC (see FIG. 2). The projector 100 is accompanied by a remote controller 91, the remote controller 91 transmits a command signal corresponding to the user's operation to a receiver 92 of the main body 2 as an infrared signal or the like, and the circuit device 80 receives the command signal via the receiver 92.

The image display device 20 includes a light source device 10, a separation optical system 20a, an image forming unit 20b, and a prism PR. When the image display device 20 has a single-plate structure, another optical member may be provided instead of the prism PR. The prism PR may also be omitted.

The light source device 10 emits in a homogenized state, light including the R light, the G light, and the B light. Although not shown in the drawings, the light source device 10 includes a light emitter such as a super high-pressure mercury lamp, a two-stage integrator lens including a plurality of lens elements arranged in an array, a polarization conversion element that converts light having passed through the two-stage integrator lens into predetermined linearly polarized light, and a superimposing lens that superimposes illumination light emitted from the integrator lens in the posterior stage on display regions of the liquid crystal panels 29R, 29G, and 29B. The light emitter may be replaced with a laser diode, and in this case, a wavelength conversion element or the like that generates fluorescence is disposed on an optical path from the laser diode.

The separation optical system 20a separates the light emitted from the light source device 10 into three colors of R, G, and B. The separation optical system 20a includes a first dichroic mirror 21, a second dichroic mirror 22, relay lenses 23, 24, reflecting mirrors 25, 26, and 27, and field lenses 28R, 28G, and 28B. The image forming unit 20b includes the liquid crystal panels 29R, 29G, and 29B, which are light modulation elements OM.

The first dichroic mirror 21 reflects the R light incident from the light source device 10 and transmits the G light and the B light. The R light reflected by the first dichroic mirror 21 is incident on the liquid crystal panel 29R via the reflecting mirror 25 and the field lens 28R to illuminate the liquid crystal panel 29R.

The second dichroic mirror 22 reflects the G light from the first dichroic mirror 21 and transmits the B light. The G light reflected by the second dichroic mirror 22 is incident on the liquid crystal panel 29G through the field lens 28G to illuminate the liquid crystal panel 29G. The B light transmitted through the second dichroic mirror 22 is incident on the liquid crystal panel 29B via the relay lenses 23, 24, the reflecting mirrors 26, 27, and the field lens 28B to illuminate the liquid crystal panel 29B.

The liquid crystal panels 29R, 29G, and 29B constituting the image forming unit 20b are transmissive spatial light modulation elements, and form images of the respective colors on a reduction-side conjugate plane of the projection optical system 40. That is, the liquid crystal panel 29R modulates the illumination light, which is the R light, in accordance with the image signal to thereby form an image of the R color. The liquid crystal panel 29G modulates the illumination light, which is the G light, in accordance with the image signal to thereby form an image of the G color. The liquid crystal panel 29B modulates the illumination light, which is the B light, in accordance with the image signal to thereby form an image of the B color.

The prism PR is, for example, a cross dichroic prism 31. The cross dichroic prism 31 is a light combining prism, and combines the light modulated by the liquid crystal panel 29R, the light modulated by the liquid crystal panel 29G, and the light modulated by the liquid crystal panel 29B into image light ML and causes the image light ML to enter the projection optical system 40.

The projection optical system 40 is a projection lens 41 that projects the image light ML modulated by the liquid crystal panels 29R, 29G, and 29B and combined by the cross dichroic prism 31 onto the screen SC (see FIG. 2) in an enlarged manner.

The circuit device 80 includes an image processor 81, a display driver 82, a lens driver 83, a ranging device 85, and a control device 88 that integrally controls operations of these circuit sections 81, 82, 83, and 85.

An external image signal IS such as a video signal is input to the image processor 81. The image processor 81 converts the external image signal IS thus received into an image signal including gradations of the colors and so on. The image processor 81 can also perform various types of image processing, such as distortion correction and color correction, on the external image signal IS.

The display driver 82 drives the liquid crystal panels 29R, 29G, and 29B provided to the optical system portion 60 based on an output of the image processor 81. That is, the display driver 82 can operate the liquid crystal panels 29R, 29G, and 29B based on the image signal output from the image processor 81, and can cause the liquid crystal panels 29R, 29G, and 29B to form images corresponding to the image signal or images corresponding to the image signal on which the image processing is performed.

The lens driver 83 operates a moving mechanism AN provided to the projection optical system 40 to adjust the state of the projection optical system 40. The lens driver 83 operates under the control of the control device 88, and adjusts the focus of the projection optical system 40 by appropriately moving the projection lens 41 constituting the projection optical system 40 along the optical axis OA with the moving mechanism AN. The moving mechanism AN includes, for example, an actuator.

The ranging device 85 operates under the control of the control device 88, and measures a projection distance L (see FIG. 2) from the main body 2 of the projector 100 to the screen SC or the projection image ahead by, for example, an optical method. Specifically, the ranging device 85 includes a light projector and a light receiver, and performs distance measurement based on the principle of triangulation and a time difference to output the measurement result to the control device 88. The ranging device 85 is required mainly at the time of an autofocus adjustment operation described later.

Referring to FIG. 3, the control device 88 includes an operation signal receiving device 882, a communication device 883, an input/output device 884, a storage device 885, and an arithmetic device 886.

The operation signal receiving device 882 receives, via the receiver 92, an infrared signal or the like emitted from the remote controller 91 (see FIG. 1). Accordingly, it is possible to perform, in accordance with operations or selection by the user using the remote controller 91, control of the projector 100 such as turning on, turning off, brightness adjustment, and focus adjustment of the projector 100.

The communication device 883 enables the control device 88 to be connected to the network NT such as the Internet. The control device 88 communicates with an external server or the like via the network NT to acquire update information, a program necessary for the operation of the projector 100, and so on. The communication device 883 may acquire information via any recording medium such as a memory card or a universal serial bus (USB) memory instead of the network NT. Further, the communication device 883 may acquire information from other devices directly coupled thereto by USB or the like. The communication device 883 includes various interfaces such as a network interface card (NIC) or USB.

Information for the arithmetic device 886 to execute processing is input to the input/output device 884. The input/output device 884 outputs a result obtained by the arithmetic device 886 performing processing. The operation or the selection by the user can also be performed with the input/output device 884 instead of the remote controller 91. The input/output device 884 includes various input devices and output devices, such as operation keys and indicators. The projection image projected by the projector 100 may be a part of the input/output device 884. The remote controller 91 (see FIG. 1) and the receiver 92 may be the input/output device 884 in a broad sense. The display driver 82 and the lens driver 83 may also be the input/output device 884 in a broad sense.

The storage device 885 stores a database DB3, a program PG3 that includes various types of data and commands, and so on for the control device 88 to execute processing described later. The storage device 885 is used as a non-transitory tangible storage medium that stores the program PG3, the database DB3, and so on. The storage device 885 is a semiconductor storage device including a RAM, a ROM, a flash memory, and so on. The program PG3 may be provided as a program product that is downloadable from a server, for example, or may be provided as a program product that is stored in a recording medium such as a USB memory.

The program PG3 includes (1) a startup time measurement program P3a, (2) a ranging program P3b, (3) an autofocus mode program (AF mode program) P3c, and (4) a manual focus mode program (MF mode program) P3d. The startup time measurement program P3a measures the startup time of the projector 100. The ranging program P3b measures a distance between the projector 100 and the projection surface or the projection image, that is, the projection distance L (see FIG. 2). The AF mode program P3c performs focus adjustment and follow-up correction in the AF mode. The MF mode program P3d performs focus adjustment and follow-up correction in the MF mode. That is, the AF mode program P3c and the MF mode program P3d include a correction program for correcting the focus position. The program PG3 may include a correction program separately from the AF mode program P3c and the MF mode program P3d.

The database DB3 includes (1) a startup time database D3a, (2) a focus adjustment database D3b, and (3) a focus correction database D3c. The startup time database D3a stores a startup time of the projector 100. The focus adjustment database D3b stores the number of focus steps (quasi-steady focus position) and a quasi-steady state reaching time in the quasi-steady focus state corresponding to the projection distance L (see FIG. 2). The focus correction database D3c stores various parameters used for the focus correction.

The quasi-steady focus state means a state in which the operation of the projector 100 is stable. The focus position of the projector 100 may be unstable due to the temperature drift in some cases at the time of startup or moving. Therefore, the focus adjustment position (the number of focus steps or the focus position) and the quasi-steady state reaching time at which the operation of the projector 100 is stabilized after a predetermined time elapses from the startup time are set. The quasi-steady focus state varies depending on the model of the projector 100, the projection distance L, the operation environment, and so on. The quasi-steady focus state is a state in which the focus position is at a focus adjustment position in a substantially stable state, and can be said to be a steady focus state, but is a condition used for the focus correction in the AF mode and the MF mode, and therefore is expressed as the quasi-steady focus state.

The arithmetic device 886 reads the program PG3 including a command and data for executing at least a part of the processing described later from the storage device 885 and executes the program PG3. The arithmetic device 886 performs drift cancellation shift for linearly changing the focus position based on the focus change rate in a period from the focus starting point to when the quasi-steady state is reached. The arithmetic device 886 includes a central processing unit (CPU) or the like.

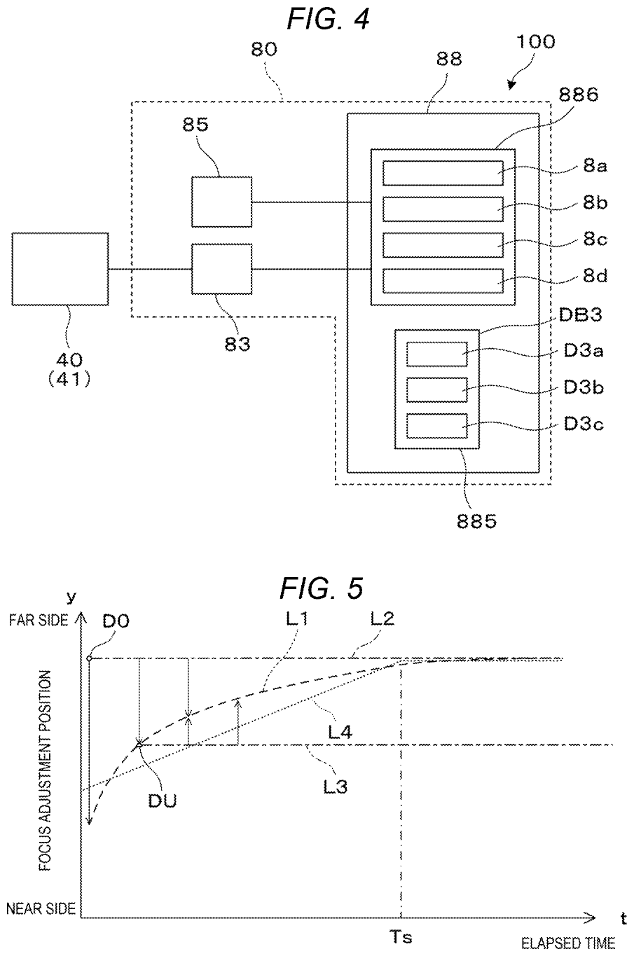

FIG. 4 is a functional block diagram of the control device 88. The control device 88 realizes a startup time measurement unit 8a, a distance acquisition unit 8b, a focus adjustment unit 8c, and a focus correction unit 8d by the arithmetic device 886 illustrated in FIG. 3 reading and executing the program PG3. The startup time measurement unit 8a measures the startup time of the projector 100 and stores the startup time in the startup time database D3a. The distance acquisition unit 8b measures the projection distance L (see FIG. 2) of the projector 100 and sends the projection distance L to the focus adjustment unit 8c, the focus correction unit 8d, and so on. The focus adjustment unit 8c performs focus adjustment with reference to the focus adjustment database D3b in accordance with the selection of the AF mode or the MF mode. The focus correction unit 8d dynamically corrects a deviation of the focus position with reference to the focus adjustment database D3b and the focus correction database D3c. The focus adjustment unit 8c performs focus adjustment in accordance with the selection of either the AF mode or the MF mode. The focus adjustment unit 8c acquires a quasi-steady focus position corresponding to the projection distance L in an AF adjustment operation. In the AF adjustment operation, the focus adjustment unit 8c changes the focus position in accordance with the drift control formula from an offset position, which is the focus starting point offset from the quasi-steady focus position, until the quasi-steady state is achieved. In an MF adjustment operation, the focus adjustment unit 8c changes the focus position in accordance with the drift control formula from a manual focus position, which is a focus starting point set manually, until the quasi-steady state is achieved. The focus correction unit 8d determines the drift control formula for performing the drift cancellation shift and an offset position that is a focus starting point.

In the projector 100, a focus drift or a temperature drift occurs due to an internal temperature change, characteristics of the projection lens 41, and so on, and the focus state changes over time. The projector 100 according to the present embodiment performs control for causing the focus to automatically follow the change in the focus state described above to keep the in-focus state.

In recent years, automatic adjustment has become mainstream for focus adjustment, and in particular, adjustment using a sensor has increased. In the autofocus operation using a sensor, it is necessary to store a focus position according to a reference distance in an assembly process. On this occasion, the focus position is adjusted in a state in which the internal temperature of the projector 100 is approximate to a steady state or a saturated state. That is, in the autofocus operation, the focus position is stored in a state where the drift of the focus position is stable and the temporal change thereof converges.

In general, when causing the projector 100 to operate, the autofocus adjustment is performed immediately after the projector 100 is started up, and the focusing operation is performed. On this occasion, in both the automatic adjustment and the manual adjustment, an inside temperature of the projector 100 as a product immediately after the startup is in a low state, and a state in which focusing is not achieved occurs due to the change over time. As a result, in a period of several tens of minutes from the startup, the projector 100 is used in a state in which the focus is not well achieved. In order to avoid this state, the projector 100 according to the present embodiment automatically controls the focus in accordance with the change over time.

FIG. 5 is a diagram illustrating the change over time in the focus position of the projector 100. In FIG. 5, the vertical axis represents the focus adjustment position, and the horizontal axis represents the elapsed time t after the startup. The focus adjustment position corresponds to the number of focus steps (focus position change amount) or the focus position. A broken line L1 illustrated in FIG. 5 indicates an ideal focus position. The ideal focus position is a focus position that cancels out the thermal fluctuation of the focus position, and is the focus position where the focus is best achieved. A dashed-dotted line L2 passing through a point D0 represents an AF drive position according to ranging at the time of startup. The dashed-dotted line L2 corresponds to the quasi-steady state focus position when thermal stability is achieved. A dashed-dotted line L3 passing through a point DU represents the manual focus position by the user operation. A dotted line L4 represents a focus position dynamically offset to the quasi-steady state, and is an approximate line following the thermal fluctuation. The reference symbol Ts denotes the quasi-steady state reaching time.

As indicated by the dashed-dotted line L2 in FIG. 5, when the thermal stability is achieved is used as a reference, the focus error is large immediately after the startup but gradually decreases with respect to the broken line L1. As indicated by the dashed-dotted line L3 in FIG. 5, when the manual setting is made is used as a reference, the focus error is small immediately after the startup but gradually increases with respect to the broken line L1.

Projection by the projector 100 is started from a state different in temperature such as a cold start state, a suspended state, or a hot start state. Here, in the cold start state, the projector 100 is turned on when the temperature of the projector 100 is lower than a predetermined temperature or in a state in which the projector 100 has not been turned on for a while. In the suspended state, the projector 100 turns on in the standby state of the projector 100. In the hot start state, the projector 100 turns on once again when the temperature of the projector 100 is equal to or higher than a predetermined temperature or in a state in which the projector 100 has been turned on until immediately before. The broken line L1 shown in FIG. 5 is not the same in the cold start state, the suspended state, and the hot start state. As described above, since the broken line L1 in FIG. 5 changes due to a disturbance of the temperature, the projector 100 according to the present embodiment performs the correction so as to be simply controlled, and performs the focus control along the dotted line L4 in which the disturbance of the temperature is thinned out.

From the fact described above, the projector 100 according to the present embodiment linearly changes the focus position so that the focus error becomes relatively small within a range of the depth of field until the quasi-steady state reaching time Ts elapses in an offset focus state with an offset from the quasi-steady focus position as represented by the dotted line L4 in FIG. 5. As described above, the projector 100 corrects the focus position by simple focus follow-up control that linearly changes. In the present embodiment, a linear function or the drift control formula is set so that the focus error is minimized in the suspended state in which the projector 100 is started up from the standby state of the projector 100.

The dotted line L4 shown in FIG. 5 represents the focal position until a quasi-steady state is reached, and is expressed in the following linear form. That is, the following expression is the drift control formula (1).

y=at+b (1)
where
y: a focus setting value (focus position)
a: an inclination coefficient (drift coefficient or focus change rate)
t: elapsed time from the startup of the projector 100
b: a starting point focus position (focus position at the time of startup or 0 minute)

The focus setting value y is a step count instruction value for the focus control. The focus setting value y varies until the quasi-steady state is achieved. By adjusting the focus position to the focus setting value y corresponding to the elapsed time t, focusing can be achieved.

The elapsed time t from the startup of the projector 100 is counted from 0 minute to 20 minutes, for example. The period of 20 minutes is an assumed time (the quasi-steady state reaching time Ts) at which the quasi-steady state in which the focus position is stabilized is reached. The quasi-steady state reaching time Ts can be appropriately changed in accordance with the model, the operating environment, and so on.

The inclination coefficient a is, for example, a step change amount per minute. In other words, the inclination coefficient a is the focus change rate or the focus temporal change amount until the quasi-steady state reaching time Ts elapses. The value of the inclination coefficient a varies depending on the model of the projector 100.

The starting point focus position b is the focus position 0 minutes after the startup. The starting point focus position b is determined when the AF mode or the MF mode is executed. The starting point focus position b is a variable value that varies in accordance with the projection distance L (see FIG. 2). The starting point focus position b is updated at the operation in the AF mode or the MF mode or switching between the AF mode and the MF mode. Although details will be described later, the starting point focus position b is not required to be used by the conversion of the drift control formula, and is therefore not required to be actually calculated.

The projector 100 performs control such that the focus position is offset toward the near side or the front side from the quasi-steady state focus position at the time of startup, the focus position is changed toward the far side or the back side linearly with respect to the elapsed time t, and the quasi-steady state focus position is reached at the quasi-steady state reaching time Ts. As described above, by offsetting the focus position from the focus position in the quasi-steady state at the time of startup, and linearly changing the focus position with a predetermined inclination with respect to the elapsed time t to restore the focus position to the original focus position, it is possible to reduce the influence of the temperature drift of the projector 100 with simple control.

The projector 100 can perform focus adjustment in the AF mode and the MF mode. The AF mode is a mode in which the projection lens 41 is driven to a target lens position corresponding to the ranging value. The MF mode is a mode in which the projection lens 41 is driven to the focus position operated by the user.

The focus follow-up control corresponds to both the AF mode and the MF mode. In the AF mode, a control formula with which the focus position moves toward the autofocus position set in advance, that is, the quasi-steady focus position is created to perform the control. In the MF mode, since the focus is achieved at a position adjusted by the user, a control formula is created to perform the control so that the focus is continuously achieved.

The focus control in the AF mode will be described below.

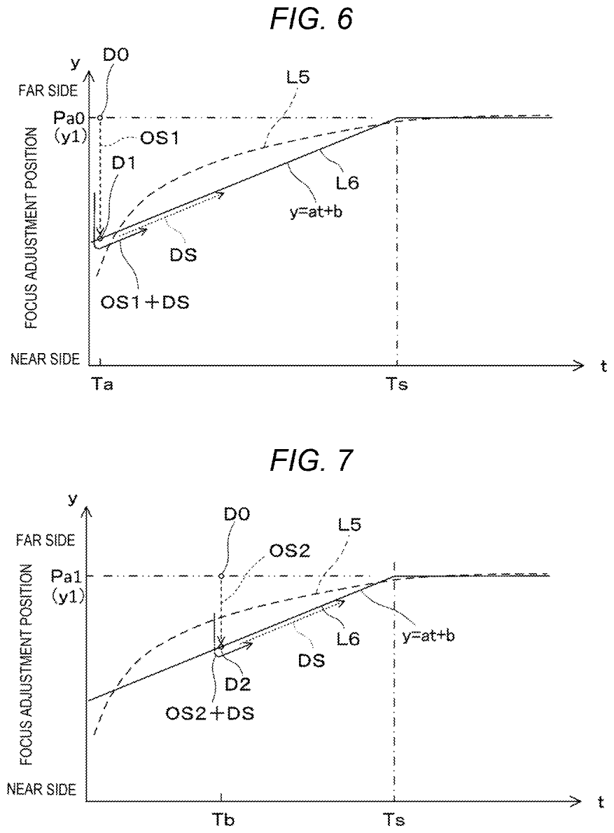

The quasi-steady focus position in the autofocus (AF) mode is a default value determined by the ranging value. In the case of the AF mode, the projection lens 41 is driven in accordance with the quasi-steady focus position immediately after the startup. Therefore, in the projector 100, defocus occurs from the beginning of the startup, and the defocus is eliminated in the quasi-steady state. The initial position of the focus follow-up control in the AF mode is an offset position D1 or an initial offset position offset from the initial autofocus (AF) position D0 corresponding to the quasi-steady focus position (see FIG. 6 and so on). The offset position D1 is a focus starting point of the drift cancellation shift.

In the AF mode, the starting point focus position b in the drift control formula (1) is expressed by the following formula (2). The quasi-steady focus setting value (quasi-steady focus position) y1 at the quasi-steady state reaching time Ts is the quasi-steady focus position determined in the AF mode.

b=y1−a×Ts (2)

The drift control formula (1) is converted into a control formula (3).

y=y1−a(Ts−t) (3)

FIG. 6 is a diagram illustrating the focus correction in the AF mode. The focus correction shown in FIG. 6 is the case based on the time of startup of the projector 100. A value Pa0 is the quasi-steady focus position corresponding to the initial AF position D0 corresponding to the projection distance L (see FIG. 2) at the time of startup. The quasi-steady focus position Pa0 corresponds to the quasi-steady focus setting value y1.

At the time of startup of the projector 100, the focus correction unit 8d of the control device 88 acquires the quasi-steady focus position Pa0 (quasi-steady focus setting value y1), the quasi-steady state reaching time Ts, and the inclination coefficient a. The focus correction unit 8d obtains the starting point focus position b by the formula (2) based on the quasi-steady focus setting value y1, the quasi-steady state reaching time Ts, and the inclination coefficient a to determine the control formula (1) described above. Further, the focus correction unit 8d determines the offset position D1 by the control formula (1). The focus adjustment unit 8c of the control device 88 performs offset shift OS1 in accordance with the control formula (1), and performs dynamic offset processing (OS1+DS) from the AF start time Ta. Accordingly, the focus adjustment unit 8c performs the focus adjustment at the offset position D1 at the AF start time Ta. Subsequently, the focus adjustment unit 8c performs the drift cancellation shift DS in accordance with the control formula (1) until the quasi-steady state reaching time Ts elapses. An ideal tracking position represented by a broken line L5 is the best focused position, and the actual tracking position represented by a solid line L6 is also the in-focus position within the depth of field. The focus correction unit 8d may determine the control formula (3) without obtaining the starting point focus position b in the formula (2).

FIG. 7 is a diagram illustrating another focus correction in the AF mode. The focus correction shown in FIG. 7 shows the case based on the time of the AF update of the projector 100. The AF update is performed when the projector 100 is moved and so on. A value Pa1 is the quasi-steady focus position corresponding to the initial AF position D0 corresponding to the projection distance L (see FIG. 2) at the time of update. The quasi-steady focus position Pa1 corresponds to the quasi-steady focus setting value y1.

At the time of update of the projector 100, the focus correction unit 8d of the control device 88 acquires the quasi-steady focus position Pa1 (quasi-steady focus setting value y1), the quasi-steady state reaching time Ts, and the inclination coefficient a. The focus correction unit 8d obtains the starting point focus position b by the formula (2) based on the quasi-steady focus setting value y1, the quasi-steady state reaching time Ts, and the inclination coefficient a to determine the control formula (1) described above. Further, the focus correction unit 8d determines an offset position D2 by the control formula (1). The focus adjustment unit 8c of the control device 88 performs offset shift OS2 in accordance with the control formula (1), and performs dynamic offset processing (OS2+DS) from an AF update time Tb. Accordingly, the focus adjustment unit 8c performs the focus adjustment at the offset position D2 at the AF update time Tb. Subsequently, the focus adjustment unit 8c performs the drift cancellation shift DS in accordance with the control formula (1) until the quasi-steady state reaching time Ts elapses.

The focus control in the MF mode will be described below.

The quasi-steady focus position of the manual focus (MF) mode is a value that is determined in the stage in which the manual focus adjustment by the user ends. The focus adjustment by the user is, for example, an electric focus operation using the remote controller 91. In the case of the MF mode, the projection lens 41 is driven in accordance with the quasi-steady focus position by an initial autofocus operation immediately after the startup, and then the user manually adjusts the focus. Therefore, in the case of the MF mode, the focus is shifted with time. In the MF mode, the first AF adjustment may be omitted. The initial position of the focus follow-up control in the MF mode is a manual focus position manually set by the user. The manual focus position is a focus starting point of the drift cancellation shift.

In the MF mode, the starting point focus position b in the drift control formula (1) is expressed by the following formula (4). A value y0 is an MF setting value (the manual focus position), and is a focus setting value determined in the MF mode. A value Tm is an MF setting time, and is the elapsed time from the startup when the MF setting value y0 is determined.

b=y0−a×Tm (4)

The drift control formula is converted into a control formula (5). In the case of the control formula (5), the quasi-steady focus setting value y1 obtained from the projection distance L as in the AF mode is unnecessary.

y=y0+a(t−Tm)=y0+aΔt (5)
where

Δt=t−Tm

The control formula (5) can also be expressed by the conditional formula (3).

y=y1−a(Ts−t) (3)

Here, the value y1 in the MF mode is the quasi-steady focus setting value or the quasi-steady focus position in the MF mode. The quasi-steady focus setting value y1 is not the quasi-steady focus setting value corresponding to the projection distance L, but is obtained from the following formula reflecting the manual setting state.

1=y0+a(Ts−Tm)

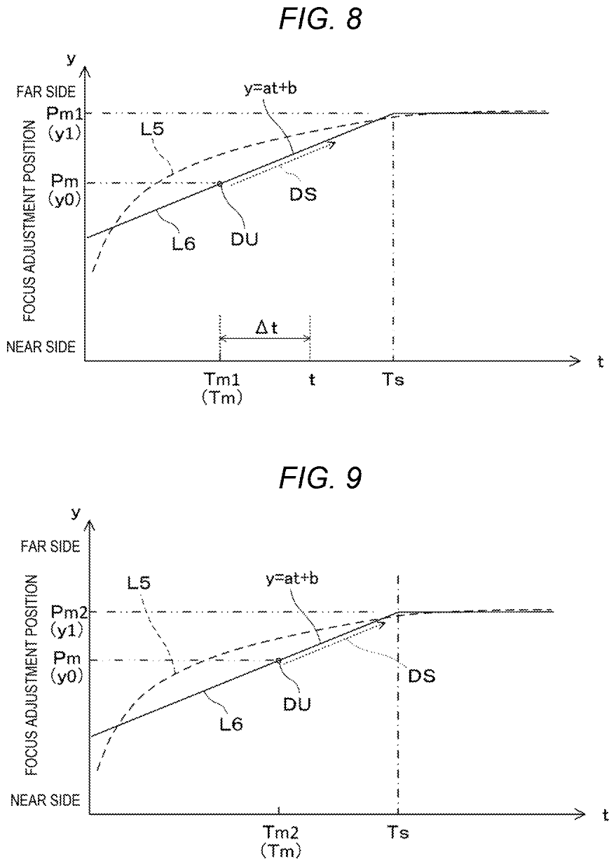

FIG. 8 is a diagram illustrating the focus correction in the MF mode. The focus correction shown in FIG. 8 is based on a first MF setting time Tm1. A value Pm1 is the quasi-steady focus position at the first MF setting time Tm1. The quasi-steady focus position Pm1 corresponds to the quasi-steady focus setting value y1 in the MF mode. A value Pm is a setting focus position at the manual focus position DU, and corresponds to the manual focus (MF) setting value y0.

At the first MF setting time Tm1, the focus correction unit 8d of the control device 88 acquires the setting focus position Pm (MF setting value y0), the elapsed time at the MF setting time Tm1, and the inclination coefficient a. The focus correction unit 8d obtains the starting point focus position b by the formula (4) based on the MF setting value y0, the elapsed time at the MF setting time Tm1, and the inclination coefficient a to determine the control formula (1) described above. The focus adjustment unit 8c of the control device 88 performs dynamic offset processing from the first MF setting time Tm1 by the control formula (1). Subsequently, the focus adjustment unit 8c performs the drift cancellation shift DS in accordance with the control formula (1) until the quasi-steady state reaching time Ts elapses. The focus correction unit 8d may determine the control formula (5) without obtaining the starting point focus position b in the formula (4). The focus correction unit 8d may acquire the quasi-steady focus position Pm1 (quasi-steady focus setting value y1), the quasi-steady state reaching time Ts, and the inclination coefficient a. In this case, the focus adjustment unit 8c performs the drift cancellation shift DS in accordance with the control formula (3).

FIG. 9 is a diagram illustrating another focus correction in the MF mode. The focus correction shown in FIG. 9 is based on a second MF setting time Tm2. The second MF setting time Tm2 is a timing different from the first MF setting time Tm1 with reference to the startup time. A value Pm2 is the quasi-steady focus position at the second MF setting time Tm2. The quasi-steady focus position Pm2 corresponds to the quasi-steady focus setting value y1 in the MF mode. The value Pm is a setting focus position at the manual focus position DU and corresponds to the MF setting value y0.

At the second MF setting time Tm2, the focus correction unit 8d of the control device 88 acquires the setting focus position Pm (MF setting value y0), the elapsed time at the MF setting time Tm2, and the inclination coefficient a. The focus correction unit 8d obtains the starting point focus position b by the formula (4) based on the MF setting value y0, the elapsed time at the MF setting time Tm2, and the inclination coefficient a to determine the control formula (1) described above. The focus adjustment unit 8c of the control device 88 performs dynamic offset processing from the second MF setting time Tm2 by the control formula (1). Subsequently, the focus adjustment unit 8c performs the drift cancellation shift DS in accordance with the control formula (1) until the quasi-steady state reaching time Ts elapses.

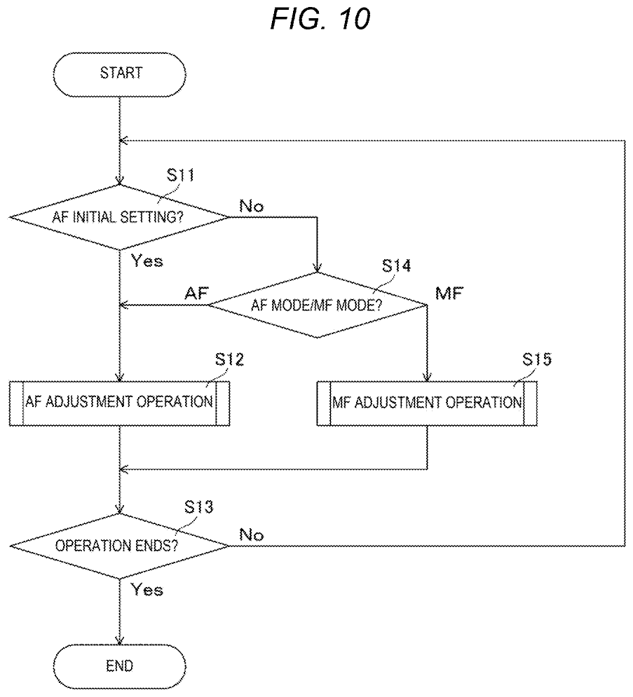

An example of the focus adjustment operation of the projector 100 will be described with reference to FIG. 10. When the projector 100 is started up, the arithmetic device 886 reads the program PG3 for controlling the focus adjustment of the projector 100 from the storage device 885 and then executes the program PG3. When the program PG3 is executed, the arithmetic device 886 repeats the processing shown in FIG. 10.

When the autofocus function is not turned off, the projector 100 executes the program PG3 to automatically execute the autofocus immediately after, for example, the startup or the movement. The AF mode and the MF mode may be switched at any timing before the startup, immediately after the startup, or during the startup of the projector 100 by the operation key of the main body 2 of the projector 100, the remote controller 91, or the like.

First, the control device 88 confirms (step S11) whether to perform an initial setting of the autofocus. When the initial setting is not performed, the update during the AF mode operation or the update during the MF mode operation is performed by interrupt.

When the initial setting of the autofocus is performed (Yes in step S11), the control device 88 causes the lens driver 83 to operate as the focus adjustment unit 8c to perform (step S12) the AF adjustment operation. On this occasion, the control device 88 appropriately performs focus follow-up control as the focus correction unit 8d.

When the operation is ended after the focus adjustment (Yes in step S13), the control device 88 ends the focus adjustment operation. When the operation is continued (No in step S13), the process returns to step S11.

In step S11, when the initial setting of the autofocus is not performed (No in step S11), the control device 88 confirms (step S14) the operation mode. When the operation mode is the AF mode (AF in step S14), the process proceeds to step S12. When the operation mode is the MF mode (MF in step S14), the control device 88 receives (step S15) the MF adjustment operation as the focus adjustment unit 8c. On this occasion, the control device 88 appropriately performs focus follow-up control as the focus correction unit 8d. Subsequently, the process proceeds to step S13.

In FIG. 10, the control device 88 may periodically perform interrupt processing to confirm which of the setting of the AF mode, the setting of the MF mode, and the drift update timing is to be performed. In the case of the AF mode setting, the starting point focus position b in the control formula (1) is determined based on the distance measurement value to perform the offset shift. In the case of the MF mode setting, the starting point focus position b in the control formula (1) is determined while adjusting the focus as instructed by the user. In the case of the drift update timing, the starting point focus position b in the control formula (1) has been determined, and the elapsed time t in the control formula (1) is input or updated to update the value of the focus setting value y, and the drift cancellation shift is performed.

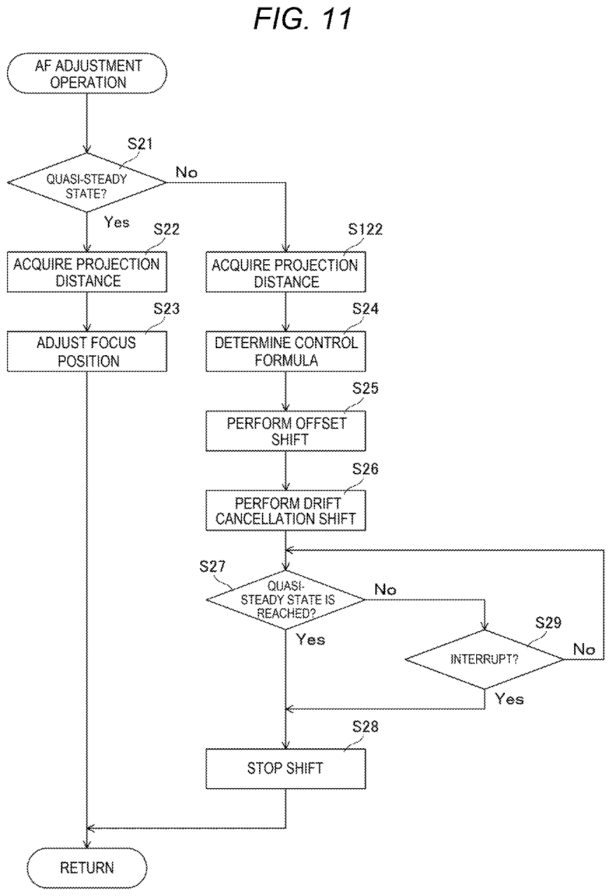

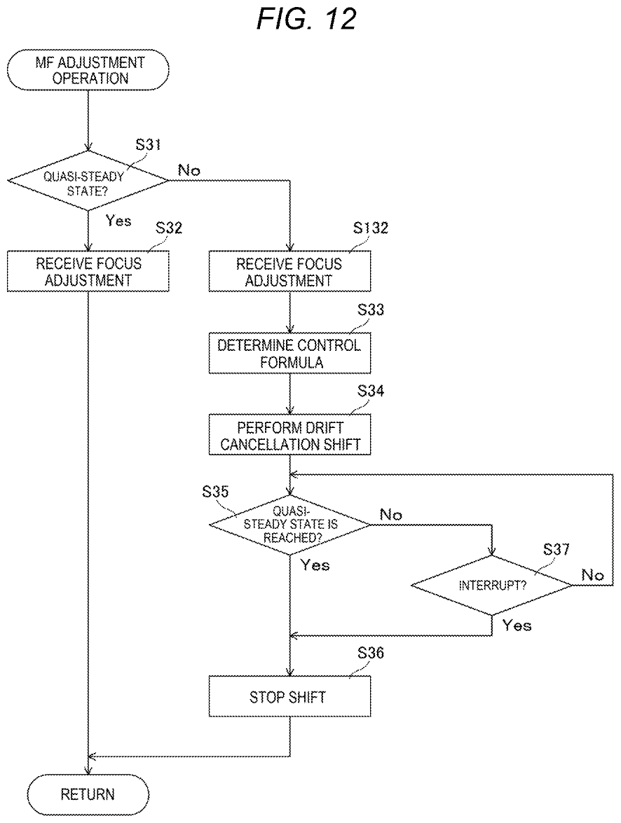

The AF adjustment operation in step S12 shown in FIG. 10 will be described with reference to FIG. 11.

First, the control device 88 confirms (step S21) whether the projector 100 is in the quasi-steady state. Specifically, when the startup time of the projector 100 measured by the startup time measurement unit 8a is equal to or longer than a predetermined time, the control device 88 determines that the projector 100 is in the quasi-steady state. The predetermined time is, for example, 20 minutes from the startup. Note that it is preferable to reconfirm the quasi-steady state when the state of the projector 100 changes due to the movement of the projector 100 or the like during the predetermined time from the startup. The quasi-steady state may be determined by the internal temperature of the projector 100.

When the projector 100 is in the quasi-steady state (Yes in step S21), the control device 88 serves as the distance acquisition unit 8b to acquire (step S22) the projection distance L of the projector 100. Thus, the quasi-steady focus position corresponding to the projection distance L is known. When there is no change from the projection distance L acquired at the time of startup or update of the projector 100, step S22 may be omitted. Subsequently, the control device 88 functions as the focus adjustment unit 8c to adjust (step S23) the focus position so as to be the quasi-steady focus position.

In step S21, when the projector 100 is not in the quasi-steady state (No in step S21), the control device 88 serves as the distance acquisition unit 8b to acquire (step S122) the projection distance L of the projector 100. When there is no change from the projection distance L acquired at the time of startup or update of the projector 100, step S122 may be omitted.

After step S122, the control device 88 determines (step S24) the drift control formula as the focus correction unit 8d. On this occasion, the focus correction unit 8d confirms the elapsed time to determine the offset position.

After step S24, the control device 88 performs (step S25) offset shift as the focus adjustment unit 8c. Specifically, the focus adjustment unit 8c causes the lens driver 83 to operate to perform step driving to the offset position obtained in step S24.

After step S25, the control device 88 performs (step S26) the drift cancellation shift as the focus adjustment unit 8c. Specifically, the focus adjustment unit 8c performs the focus follow-up control from the offset position using the drift control formula obtained in step S24.

Subsequently, the control device 88 confirms (step S27) whether the quasi-steady state has been reached. When the quasi-steady state has been reached (Yes in step S27), the control device 88 stops (step S28) the shift.

When the quasi-steady state has not been reached (No in step S27), the control device 88 confirms (step S29) the presence or absence of an interrupt. The interrupt is a processing request related to a user instruction such as a key operation related to the focus or an operation end of the apparatus.

When there is an interrupt (Yes in step S29), the process proceeds to step S28. When there is no interrupt (No in step S29), the process returns to step S27.

The MF adjustment operation in step S15 illustrated in FIG. 10 will be described with reference to FIG. 12.

First, the control device 88 confirms (step S31) whether the projector 100 is in the quasi-steady state.

When the projector 100 is in the quasi-steady state (Yes in step S31), the control device 88 receives (step S32) manual focus adjustment by a user operation.

In step S31, when the projector 100 is not in the quasi-steady state (No in step S31), the control device 88 receives (step S132) the manual focus adjustment by the user operation.

After step S132, the control device 88 determines (step S33) the drift control formula as the focus correction unit 8d.

After step S33, the control device 88 performs (step S34) the drift cancellation shift as the focus adjustment unit 8c. Specifically, the focus adjustment unit 8c performs focus follow-up control from the manual focus position using the drift control formula obtained in step S33.

Subsequently, the control device 88 confirms (step S35) whether the quasi-steady state has been reached. When the quasi-steady state has been reached (Yes in step S35), the control device 88 stops (step S36) the shift.

When the quasi-steady state has not been reached (No in step S35), the control device 88 confirms (step S37) the presence or absence of an interrupt.

When there is an interrupt (Yes in step S37), the process proceeds to step S36. When there is no interrupt (No in step S37), the process returns to step S35.

The projector 100 described above includes the projection lens 41 and the control device 88 that controls the focus of the projection lens 41, and the control device 88 performs the drift cancellation shift of linearly changing the focus position based on the focus change rate from the focus starting point until the quasi-steady state is reached.

In the projector 100 described above, by the simple focus control of linearly changing the focus position based on the focus change rate from the focus starting point until the quasi-steady state is reached, it is possible to project a good projection image while minimizing the focus error to the quasi-steady state.

### Other Issues

The structures described above are illustrative only, and can variously be changed within a range in which substantially the same functions can be achieved.

For example, the configuration of the projector 100 can be changed as appropriate. For example, a target to be projected in an enlarged manner by the projection optical system 40 is not limited to an image formed by the liquid crystal panels 29R, 29G, and 29B, and an image formed by a light modulation element such as a digital micromirror device can be projected in an enlarged manner.

In the embodiment described above, the focus correction unit 8d of the control device 88 sets the drift control formula so that the focus error is minimized in the suspended state, but the drift control formula may be set so that the focus error is minimized in the cold start state or the hot start state.

The control device 88 may change the inclination coefficient a (focus change rate) of the drift control formula, the quasi-steady state reaching time Ts, and so on in accordance with the internal temperature of the projector 100 at the time of startup. For example, the control device 88 changes the drift control formula in accordance with the state of the projector 100 such as the cold start state, the suspended state, and the hot start state. In this case, the projector 100 includes a temperature measurement device such as a temperature sensor. By giving temperature dependency to the drift control formula, correction accuracy can be improved.

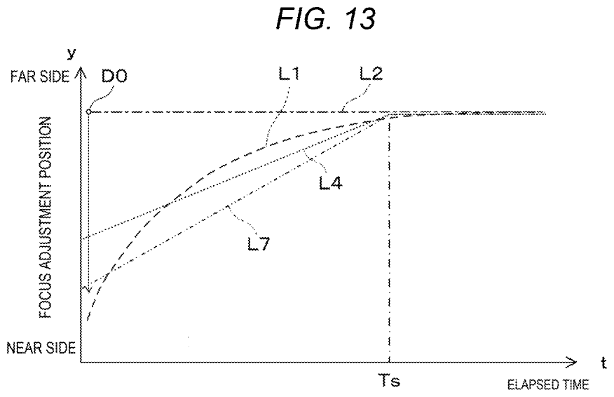

FIG. 13 is a diagram illustrating an example of temperature-dependent focus correction. As shown in FIG. 13, the inclination coefficient a (focus change rate) in the drift control formula represented by a dashed-two dotted line L7 in the case of the cold start state is larger than the inclination coefficient a represented by the dotted line L4 in the case of the suspended state.

### Summary of Present Disclosure

The present disclosure will be summarized below as appendices.

### Appendix 1

A projector including:
a projection lens; and
a control device configured to control focus of the projection lens, wherein
the control device performs drift cancellation shift for linearly changing a focus position based on a focus change rate from a focus starting point until a quasi-steady state is reached.

By the simple focus control of linearly changing the focus position based on the focus change rate from the focus starting point until the quasi-steady state is reached, it is possible to project a good projection image while minimizing the focus error to the quasi-steady state.

### Appendix 2

The projector according to Appendix 1, wherein
the control device includes
a focus adjustment unit configured to perform focus adjustment in accordance with selection of one of an autofocus mode and a manual focus mode, and
a focus correction unit configured to dynamically correct deviation of the focus position.

Both the autofocus mode and the manual focus mode can support focus correction.

### Appendix 3

The projector according to one of Appendices 1 and 2, wherein
the drift cancellation shift is performed in accordance with the following drift control formula.

y=y1−a(Ts−t)
where
y: the focus position
y1: a quasi-steady focus position in the quasi-steady state
a: the focus change rate
Ts: a quasi-steady state reaching time from startup until the quasi-steady state is reached
t: an elapsed time from startup

In particular, the control formula is effective when performing the autofocus adjustment operation.

### Appendix 4

The projector according to one of Appendices 1 and 2, wherein
the drift cancellation shift is performed in accordance with the following drift control formula.

y=y0+a(t−Tm)
where
y: the focus position
y0: a manual focus position
a: the focus change rate
Tm: an elapsed time from startup when the manual focus position is determined
t: an elapsed time from startup

The control formula is used when performing a manual focus adjustment operation. When performing only the manual focus adjustment, the ranging device is unnecessary.

### Appendix 5

The projector according to Appendix 3, wherein
the control device includes
a focus adjustment unit configured to perform an autofocus adjustment operation, and
a focus correction unit configured to determine the drift control formula and an offset position that is the focus starting point offset from the quasi-steady focus position, and
the focus adjustment unit changes the focus position in accordance with the drift control formula from the offset position until the quasi-steady state is reached in the autofocus adjustment operation.

### Appendix 6

The projector according to Appendix 5, further including
a ranging device configured to measure a projection distance, wherein
the focus adjustment unit acquires the quasi-steady focus position corresponding to the projection distance in the autofocus adjustment operation.

### Appendix 7

The projector according to any one of Appendices 3 to 6, wherein
the control device includes
a focus adjustment unit configured to perform a manual focus adjustment operation, and
a focus correction unit configured to determine the drift control formula, and
the focus adjustment unit changes the focus position in accordance with the drift control formula from a manual focus position, which is the focus starting point set manually, until the quasi-steady state is reached in the manual focus adjustment operation.

### Appendix 8

A control device configured to control focus of a projection lens of a projector, wherein
drift cancellation shift that linearly changes a focus position based on a focus change rate from a focus starting point until a quasi-steady state is reached is performed.

By the simple focus control of linearly changing the focus position based on the focus change rate from the focus starting point until the quasi-steady state is reached, it is possible to minimize the focus error to the quasi-steady state.

### Appendix 9

A non-transitory computer-readable storage medium storing a program configured to control focus of a projection lens of a projector, comprising
causing an arithmetic device to execute drift cancellation shift that linearly changes a focus position based on a focus change rate from a focus starting point until a quasi-steady state is reached.

By the simple focus control of linearly changing the focus position based on the focus change rate from the focus starting point until the quasi-steady state is reached, it is possible to minimize the focus error to the quasi-steady state.

What is claimed is:

1. A projector comprising:
a projection lens; and
a control device configured to control focus of the projection lens, wherein
the control device performs drift cancellation shift for linearly changing a focus position based on a focus change rate from a focus starting point until a quasi-steady state is reached.

2. The projector according to claim 1, wherein
the control device includes
a focus adjustment unit configured to perform focus adjustment in accordance with selection of one of an autofocus mode and a manual focus mode, and
a focus correction unit configured to dynamically correct deviation of the focus position.

3. The projector according to claim 1, wherein
the drift cancellation shift is performed in accordance with the following drift control formula.
y=y1−a(Ts−t)
where
y: the focus position
y1: a quasi-steady focus position in the quasi-steady state
a: the focus change rate
Ts: a quasi-steady state reaching time from startup until the quasi-steady state is reached
t: an elapsed time from startup

4. The projector according to claim 1, wherein
the drift cancellation shift is performed in accordance with the following drift control formula.
y=y0+a(t−Tm)
where
y: the focus position
y0: a manual focus position
a: the focus change rate
Tm: an elapsed time from startup when the manual focus position is determined
t: an elapsed time from startup

5. The projector according to claim 3, wherein
the control device includes
a focus adjustment unit configured to perform an autofocus adjustment operation, and
a focus correction unit configured to determine the drift control formula and an offset position that is the focus starting point offset from the quasi-steady focus position, and
the focus adjustment unit changes the focus position in accordance with the drift control formula from the offset position until the quasi-steady state is reached in the autofocus adjustment operation.

6. The projector according to claim 5, further comprising
a ranging device configured to measure a projection distance, wherein
the focus adjustment unit acquires the quasi-steady focus position corresponding to the projection distance in the autofocus adjustment operation.

7. The projector according to claim 3, wherein
the control device includes
a focus adjustment unit configured to perform a manual focus adjustment operation, and
a focus correction unit configured to determine the drift control formula, and
the focus adjustment unit changes the focus position in accordance with the drift control formula from a manual focus position, which is the focus starting point set manually, until the quasi-steady state is reached in the manual focus adjustment operation.

8. A control device configured to control focus of a projection lens of a projector, wherein
drift cancellation shift that linearly changes a focus position based on a focus change rate from a focus starting point until a quasi-steady state is reached is performed.

9. A non-transitory computer-readable storage medium storing a program configured to control focus of a projection lens of a projector, comprising
causing an arithmetic device to execute drift cancellation shift that linearly changes a focus position based on a focus change rate from a focus starting point until a quasi-steady state is reached.
